(19) United States
(12) Patent Application Publication
(10) Pub. No.: US 2017/0114994 A1
(43) Pub. Date: Apr. 27, 2017

(54) Inflatable foil balloon with lettering & graphics printed with translucent colored inks which are illuminated by exterior LED lights

(71) Applicants: Kurt Christian Kosted, Pflugerville, TX (US); Randy Martin Kosted, Kalispel, MT (US); Phillip Wayne Kosted, Rusk, TX (US)

(72) Inventors: Kurt Christian Kosted, Pflugerville, TX (US); Randy Martin Kosted, Kalispel, MT (US); Phillip Wayne Kosted, Rusk, TX (US)

(21) Appl. No.: 15/330,090

(22) Filed: Nov. 13, 2014

(51) Int. Cl. F21V 33/00; A63H 27/10; F21V 23/04; F21L 4/02; F21V 23/00

(52) U.S. Cl. CPC F21V 33/008; F21L 4/02; F21V 23/003; F21V 23/0414; F21V 23/0407; A63H 27/10; F21Y 2115/10

(57) ABSTRACT

An illuminated inflatable balloon assembly having translucent graphics associated with the exterior of the balloon, a clear window extending through the balloon, a light source positioned over the clear window, a power source, a controller for controlling the illumination of the light source, and an on/off switch for controlling power to the light source. In one embodiment, the controller causes the light source to repeatedly flash when power is supplied thereto.

### FIELD OF THE INVENTION

The present invention relates generally to illuminated inflatable balloons and, more particularly, to an illuminated inflatable foil balloon having lettering and graphics printed on the exterior surface of the balloon with translucent colored inks which are illuminated by LED lights attached to the exterior of the balloon.

### BACKGROUND OF THE INVENTION

Illuminating balloons through the use of lights externally affixed to the outside portion of a balloon is not new and dates back to at least the 1970s. See, for example, U.S. Pat. No. 3,672,083 entitled ‘Inflatable and Illuminable Figure’. Other lighted balloons include illuminated balloon assemblies as disclosed in U.S. Pat. Nos. 5,807,157; 6,482,065; 6,821,183; 7,077,553; 7,147,536; 7,318,765; 7,364,488; 7,551,061; 7,914,360; 8,297,778; 8,789,981 and Patent Application Publication No. 2014/0003034.

### SUMMARY OF THE INVENTION

The present invention is an inflatable balloon having lettering and graphics printed on the exterior surface of the balloon body with translucent ink, a light source, a controller programmed to control the light source, a power source, and a clear window for allowing the light source to enter the interior portion of the balloon. The exterior background colors associated with the exterior portion of the balloon body (visible from outside the balloon) are printed with opaque inks that surround the translucent graphics and the interior of the balloon includes a standard interior reflective backing material visible only from inside the balloon. The balloon body includes a clear window over which at least one LED light is attached so that light generated by the at least one LED light can enter the interior portion of the balloon. The LED lights are attached to the balloon using an adhesive coated reflective material such that all of the light emitted by the LED lights is focused through the clear window to the interior of the balloon and is thereafter reflected by the reflective backing material associated with the interior of the balloon. As light bounces around within the interior portion of the balloon, it is allowed to escape through the translucent ink at which point the graphics become illuminated.

### BRIEF DESCRIPTION OF THE DRAWINGS

FIG. 1 is a front elevational view of an inflatable foil balloon constructed in accordance with the teachings of the present invention having opaque and translucent ink as well as a clear window associated with the foil balloon.

FIG. 2 is a partial front elevational view of FIG. 1 illustrating one embodiment of the present invention wherein a single LED light source and its associated electrical connections are positioned over the clear window associated with the present balloon.

FIG. 3 is a partial front elevational view of FIG. 1 illustrating another embodiment of the present invention wherein a plurality of LED lights are positioned over the clear window of the present balloon, the lights being electrically coupled to a controller, a sound generator and a piezoelectric buzzer.

FIG. 4 is a partial front elevational view of FIG. 1 illustrating still another embodiment of the present invention wherein a plurality of LED lights are positioned over the clear window of the present balloon, the LED lights being coupled to a controller, and including a microphone for synchronizing the LED lights to an external sound source.

### DETAILED DESCRIPTION OF THE INVENTION

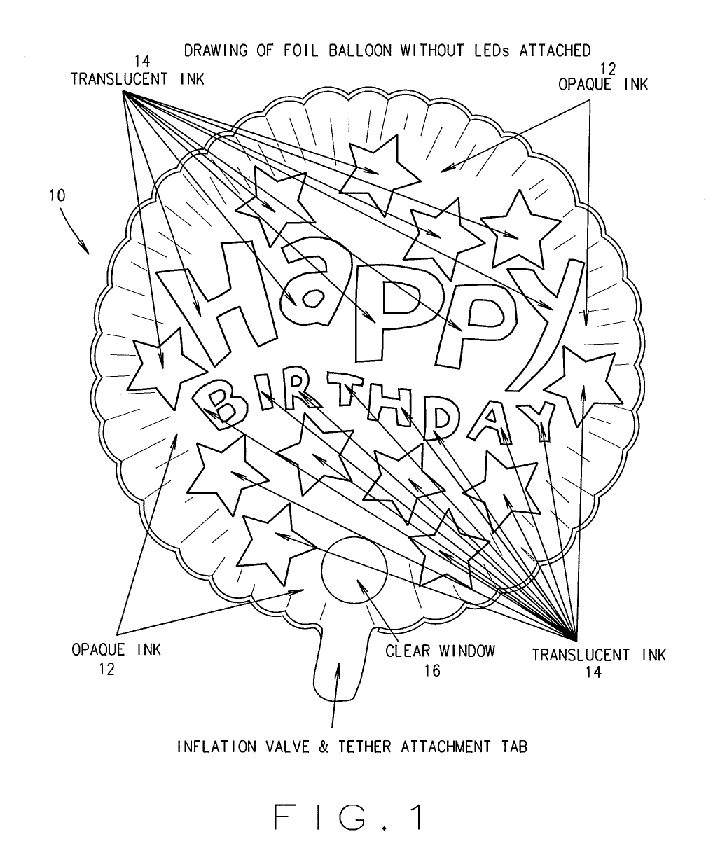

Referring to the drawings more particularly by reference numbers wherein like numerals refer to like parts, FIG. 1 illustrates one embodiment of the present illuminated foil balloon 10 showing a front elevational view of one side of the present balloon wherein both opaque inks 12 as well as translucent inks 14 have been used on the exterior surface of the balloon to create lettering and graphics on the exterior surface thereof. More particularly, the exterior background colors on the balloon 10 have been printed with the opaque inks 12 and the lettering and graphics have been printed with the translucent inks 14.

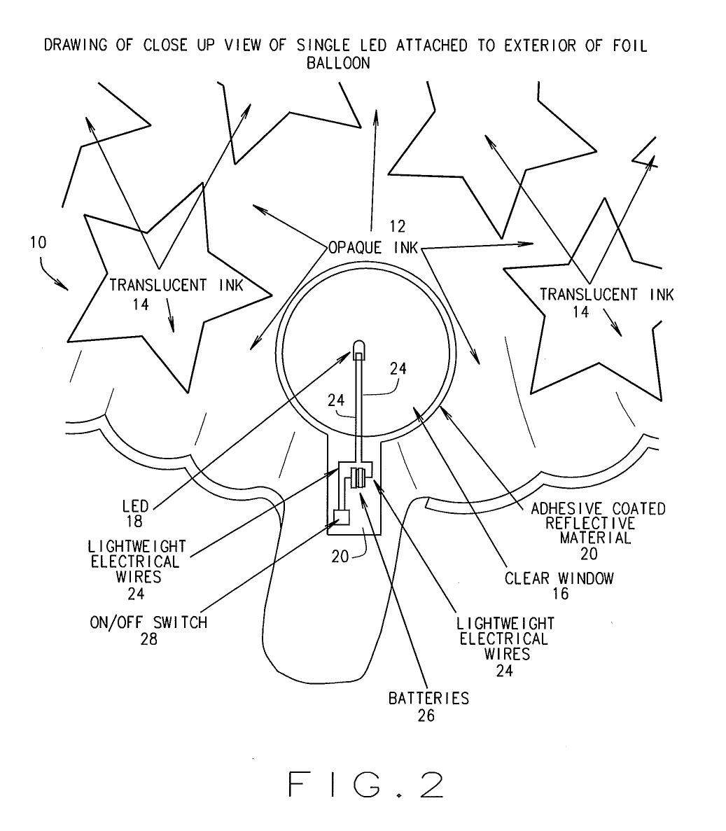

A clear window 16 is formed on one side of the balloon 10 as illustrated in FIG. 1 and the light source 18 illustrated in FIG. 2 is attached to the balloon 10 over the clear window 16 using an adhesive coated reflective material so that all of the light emitted by the LED light source 18 is focused through the clear window 16 to the interior space of the inflated balloon 10. The light source 18 is positioned between the reflective material 20 and the clear window 16. Any light entering the interior space of balloon 10 through window 16 is reflected by the reflective backing inside the balloon until it is allowed to exit through the graphic pattern and lettering created by the translucent inks 14 at which point the lettering and graphics are illuminated.

The LED lights can be a single LED or multiple colored LED lights so that as each colored LED light turns on, the color of the illuminated translucent lettering and graphics appears to change. As illustrated in FIG. 2, a single LED light source 18 is electrically coupled via electrical wires 24 to at least one battery 26 and an on/off switch 28 is likewise electrically wired to both the light source 18 and the at least one battery 26 for turning the light source on and off in a conventional manner.

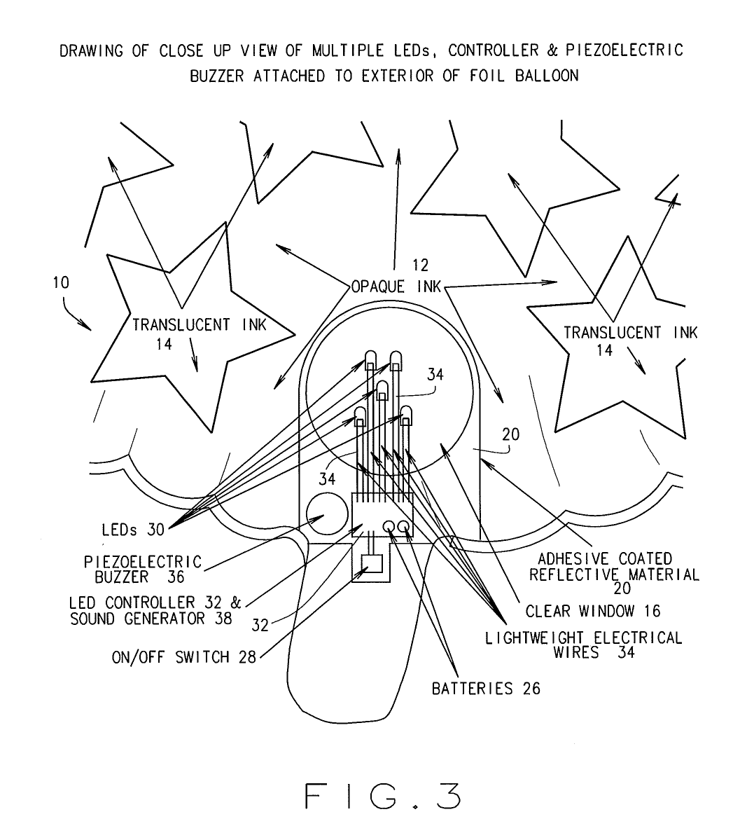

FIG. 3 illustrates a plurality of LED lights 30 positioned over the clear window 16. A controller 32 is electrically connected to the LED lights 30 via electrical wires 34 and the controller 32 is programmed so as to cause either a single LED light such as LED light 18 or the LED lights 30 to blink or flash independently of each other in a sequence programmed into controller 32.

FIG. 3 also includes a piezoelectric buzzer 36 and a sound generator 38 which are configured in a conventional manner and coupled to controller 32 so as to produce musical sounds coming out of the piezoelectric buzzer 36. It is also well-known in the art to synchronize the flashing LED lights 30 to the musical sounds generated by the sound generator 38 and coming out of the piezoelectric buzzer 36 through well-known circuitry and sequences.

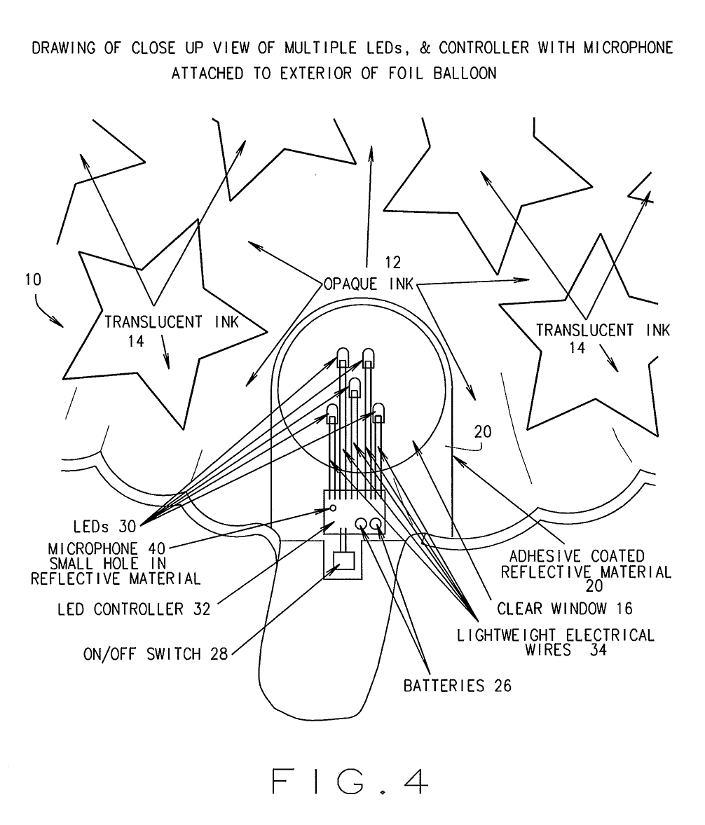

A slightly more advanced LED controller 32 as illustrated in FIG. 4 could also include a small microphone 40 so that the blinking or flashing of the LED lights 30 can be synchronized with music received by the microphone 40 from an external sound system. A switch 28 again is incorporated to turn off the LED lights when not in use.

1. (canceled)

2. A method for illuminating the translucent lettering and/or graphics on an inflatable balloon having interior and exterior surfaces, the method comprising:
providing a clear window associated with said balloon, said window extending between the interior and exterior surfaces of said balloon;
creating graphics associated with the exterior surface of said balloon, said graphics being created with translucent ink;
attaching a light source to a reflective material, and further attaching the light source to the exterior surface of said balloon over said clear window such that said light source is located between the reflective material and the clear window;
providing a power source coupled to said light source;
providing a controller coupled to said light source and to said power source for controlling the illumination of the light source; and
providing an on/off switch coupled to said power source for controlling power to the light source.

3. The method defined in claim 2 including programming said controller to repeatedly flush said light source when power is supplied to said light source.

4. The method defined in claim 2 wherein said light source includes a plurality of LED lights.

5. The method defined in claim 4 wherein said plurality of LED lights include multi-colored lights.

6. The method defined in claim 2 wherein said power source, said controller and said on/off switch are attached to the exterior surface of said balloon.

7. The method defined in claim 2 wherein the interior surface of said balloon includes a reflective backing material.

8. The method defined in claim 2 wherein said balloon is a foil balloon.

9. The method defined in claim 2 wherein the exterior surface of said balloon includes opaque areas surrounding the graphics associated therewith.

10. The method defined in claim 9 wherein said opaque areas are formed with opaque ink.
